(19) United States
(12) Patent Application Publication
(10) Pub. No.: US 2010/0070752 A1
(43) Pub. Date: Mar. 18, 2010

(54) Stable Active X Linux based operating environment

(76) Inventor: Robb Fujioka, Manhattan Beach, CA (US)

Correspondence Address: Drinker Biddle & Reath LLP, One Logan Square, 18th and Cherry Streets, Philadelphia, PA, 19103-6996, US

(21) Appl. No.: 12/584,265

(22) Filed: Sep. 2, 2009

Related U.S. Application Data
(60) Provisional application No. 61/190,809, filed on Sep. 2, 2008.

(51) Int. Cl. G06F 15/177

(52) U.S. Cl. 713/2

(57) ABSTRACT

An engine, system and method of providing a stable ActiveX Linux-based operating system. The engine, system and method include a plurality of computing hardware, capabilities for booting the plurality of computing hardware using a Linux operating system, and capabilities for accessing, via a scripting compatibility layer that ports non-native applications to the Linux operating system, of an ActiveX enabled web browser that is non-native to the Linux operating system.

### CROSS REFERENCE TO RELATED APPLICATIONS

This application claims priority to U.S. Provisional Patent Application Ser. No. 61/190,809, entitled “A Stable ActiveX Linux Based Operating Environment” and filed on Sep. 2, 2008, the entirety of which is hereby incorporated by reference as if set forth herein in the entirety.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to Linux based operating systems, and, more particularly, to a stable Active X Linux based operating environment.

2. Description of the Background

ActiveX was introduced in 1996 by Microsoft for use with its COM programming language model. Due to the introduction by Microsoft, ActiveX is generally employed in applications operated by the Windows operating system, although the ActiveX model is not exclusive to the Windows operating system. Nonetheless, the development of ActiveX by Microsoft has historically caused ActiveX to run best in conjunction with Windows and Windows-based applications. Such applications, needless to say, include Microsoft's web-based and web-interactive applications, including Internet Explorer.

More specifically, ActiveX is a framework for defining software components that are reusable. These components may perform a particular function or set of functions in a manner independent of the implementing programming language. ActiveX may thus be employed to compose a software application having functionality dictated by one or more ActiveX components.

Windows applications, including the aforementioned Internet Explorer, as well as Microsoft Office and Windows Media Player often employ ActiveX to provide functionality and/or feature sets. Internet Explorer, for example, allows for the embedding of ActiveX controls onto web pages.

ActiveX may be used to create distributed and/or customized applications for operation over the Internet. Thus, ActiveX controls are similar to Java applets, at least in that each provide download and execution to web browsers. On the other hand, ActiveX and Java are disimilar at least in that Java may run on nearly any platform, while ActiveX has historically run efficiently and with stability only on the Internet Explorer web browser running in the Microsoft Windows operating system.

Therefore, the need exists for an engine, system and method of providing stable, efficient ActiveX control in a non-Windows operating environment.

### BRIEF SUMMARY OF THE INVENTION

The present invention is and includes at least an engine, system and method of providing a stable ActiveX Linux-based operating system. The engine, system and method include a plurality of computing hardware, capabilities for booting the plurality of computing hardware using a Linux operating system, and capabilities for accessing, via a scripting compatibility layer that ports non-native applications to the Linux operating system, of an ActiveX enabled web browser that is non-native to the Linux operating system.

The present invention solves problems experienced with the prior art because it provides an engine, system and method of providing stable, efficient ActiveX control in a non-Windows operating environment. Those and other advantages and benefits of the present invention will become apparent from the detailed description of the invention hereinbelow.

### BRIEF DESCRIPTION OF THE SEVERAL VIEWS OF THE DRAWING

Understanding of the present invention will be facilitated by consideration of the following detailed description of the preferred embodiments of the present invention taken in conjunction with the accompanying drawings, in which like numerals refer to like parts, and wherein:

FIG. 1 is an illustration of aspects of the present invention.

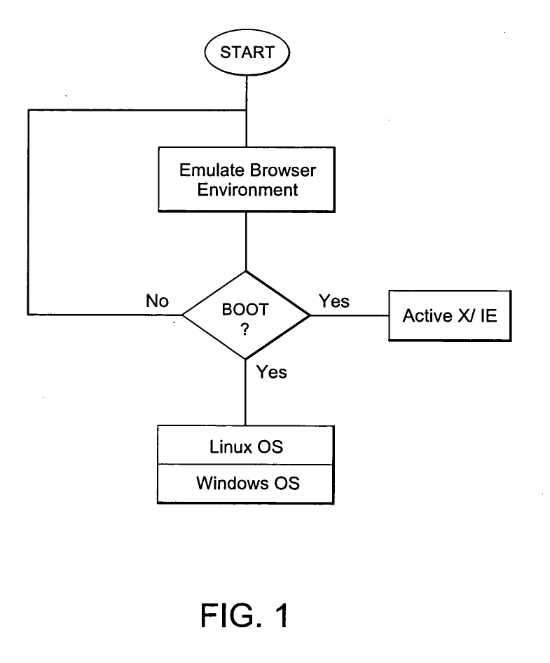

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical operating systems and software applications. Those of ordinary skill in the art will recognize that other elements are desirable and/or required in order to implement the present invention. However, because such elements are well known in the art, and because they do not facilitate a better understanding of the present invention, a discussion of such elements is not provided herein.

Linux is a generic term referring for a particular type of an operating system. Linux operating systems provide a Unix, or Unix like, environment based in the Linux kernel of the type initially created in 1991. Linux is an open source software environment. As such, the Linux operating system is freely modifiable. More particularly, a Linux environment may be modified to be provided prior to, or in parallel with, other operating systems, such as the Windows® operating system by Microsoft. As such, computing hardware may provide a Linux environment upon bootup, or an application made available via the Linux environment at boot up, even on a Windows-based computer.

Linux may be used on any type of microcomputing system. As will be appreciated by those skilled in the art, such systems include typical computers, including, for example, netbooks, servers, embedded devices, mobile devices, and the like. The popularity of Linux, particularly on standard desktops and laptops, has been increasing in recent years.

An exemplary, known Linux operating system (OS) is gOS. The newest version of gOS is a Linux OS referred to as gOS 3 Gadgets. gOS 3 Gadgets allows for an instant launch of, among other programs, Google Gadgets for Linux on startup. This gives users access to more than 100,000 iGoogle and Google Gadgets that can be readily added to the desktop in seconds over the Internet. In the instant invention, gOS 3 Gadgets may also preload WINE, and, for example, LXDE (Lightweight X Desktop Environment), and other Google software for Linux. By preloading WINE 1.0, gOS 3 Gadgets enables Windows applications to run well on the Linux platform.

WINE is not a Windows emulator. Rather, WINE runs Windows applications from scripts, thus allowing the leveraging of a Linux environment to run the Windows applications. Wine was also designed to operate as a thin client, thereby allowing the use of Windows applications from a Linux environment locally or remotely, such as via the Internet, an intranet, an extranet, or the like.

WINE is open source software. As such, WINE is capable of modification in running scripts. In essence, WINE implements the Windows Win32 and Win16 APIs on top of Linux. Thus, WINE is merely one example of a Windows compatibility layer in the present invention.

In the present invention, such a Windows compatibility layer may provide a general purpose scripting for use with any language, and particularly with any COM capable language, and more particularly with any application designed to operate in an environment employing a COM capable language. In an operating system, a COM file is typically a type of executable file. Although initially COM files used the file extension “.com” in a COM capable language, this extension is no longer required in most operating systems. As discussed hereinabove, ActiveX is designed to run in a COM capable environment, and, more particularly, ActiveX is designed to run in Microsoft's Windows COM capable environment.

The scripting of the present invention may provide compatibility, such as via a direct boot, of the Internet Explorer with the Linux operating system. More particularly, the present invention provides a compatibility layer that may use scripting to port ActiveX, Windows-based sources to a Linux operating environment.

For example, the present invention may provide that, by preloading WINE 1.0, gOS 3 Gadgets may allow for the Linux operating system of the present invention to boot directly to Microsoft's Internet Explorer (IE). Thereby, the present invention allows for a boot to IE in a Linux environment and without a Microsoft OS kernel, at least in that the compatibility layer of the present invention allows for the scripted porting of IE into the Linux environment generated at boot up. Thereby, the present invention can readily provide a stable, Active X enabled environment at boot up.

Similarly, the present invention may emulate a browser environment at start-up, such as by providing a compatibility layer, such as by use of software such as WINE, and may thereby boot directly into IE. Thereby, via the ready provision of a stable Active X environment, the present high rate of development of software for a Linux operating environment can continue unimpeded by the instability often present in a non-IE browser environment.

Further, for example, using an open source OS, such as a mobile open source OS, such as Android by Google, a typical Microsoft OS may be “peeled away,” such as to allow for the placement of advertisements via, or in association with, ActiveX. This peeling away may be provided by placing control in a software layer below the typical layer in which such control is provided, such as by taking control using Android or the like, and then providing control, such as OS control, in the enabling layer for Android. That is, control may be enabled by a compatibility layer not typically associated with IE. This compatibility layer is provided in accordance with the present invention.

The disclosure herein is directed to the variations and modifications of the elements and methods of the invention disclosed that will be apparent to those skilled in the art in light of the disclosure herein.

Thus, it is intended that the present invention covers the modifications and variations of this invention, provided those modifications and variations come within the scope of the appended claims and the equivalents thereof.

What is claimed is:

1. A stable ActiveX Linux-based operating environment, comprising:
a Linux operating system;
an ActiveX enabled web browser that is non-native to said Linux operating system;
a scripting compatibility layer that ports said ActiveX enabled web browser to said Linux operating system;
a computing hardware boot that directs a bootup directing to said ActiveX enabled web-browser via said Linux operating system using said scripting compatibility layer.

2. The environment of claim 1, wherein said ActiveX enabled web browser comprises a COM capable application.

3. The environment of claim 2, wherein said ActiveX enabled web browser comprises Internet Explorer.

4. The environment of claim 1, wherein said scripting compatibility layer comprises WINE.

5. The environment of claim 4, wherein said scripting compatibility layer further comprises gOS 3 Gadgets.

6. The environment of claim 1, wherein said Linux operating system comprises gOS.

7. The environment of claim 6, wherein said Linux operating system comprises gOS 3 Gadgets.

8. The environment of claim 1, wherein said computing hardware boot comprises exclusively a non-Microsoft kernel.

9. The environment of claim 1, wherein said computing hardware boot further comprises mobile computing hardware.

10. A method of providing a stable ActiveX Linux-based operating environment, comprising:
providing a plurality of computing hardware;
booting the plurality of computing hardware using a Linux operating system; and
accessing, via a scripting compatibility layer that ports non-native applications to the Linux operating system, of an ActiveX enabled web browser that is non-native to the Linux operating system.

11. A stable ActiveX Linux-based operating system, comprising:
a plurality of computing hardware;
means for booting the plurality of computing hardware using a Linux operating system; and
means for accessing, via a scripting compatibility layer that ports non-native applications to the Linux operating system, of an ActiveX enabled web browser that is non-native to the Linux operating system.

12. The stable ActiveX Linux-based operating system of claim 11, wherein said ActiveX enabled web browser comprises a COM capable application.

13. The stable ActiveX Linux-based operating system of claim 12, wherein said ActiveX enabled web browser comprises Internet Explorer.

14. The stable ActiveX Linux-based operating system of claim 11, wherein said scripting compatibility layer comprises WINE.

15. The stable ActiveX Linux-based operating system of claim 14, wherein said scripting compatibility layer further comprises gOS 3 Gadgets.

16. The stable ActiveX Linux-based operating system of claim 11, wherein said Linux operating system comprises gOS.

17. The stable ActiveX Linux-based operating system of claim 16, wherein said Linux operating system comprises gOS 3 Gadgets.

18. The stable ActiveX Linux-based operating system of claim 11, wherein said means for booting comprises exclusively a non-Microsoft kernel.

19. The stable ActiveX Linux-based operating system of claim 11, wherein said plurality of computing hardware comprises mobile computing hardware.

20. The stable ActiveX Linux-based operating system of claim 11, wherein said plurality of computing hardware comprises desktop computing hardware.
